(19) United States
(12) Patent Application Publication
(10) Pub. No.: US 2024/0282078 A1
(43) Pub. Date: Aug. 22, 2024

(54) NON-INTRUSIVE OPTICAL ASSESSMENTS FOR HELIOSTAT ERROR DETECTION

(71) Applicant: Alliance for Sustainable Energy, LLC, Golden, CO (US)

(72) Inventors: Devon James KESSELI, Boulder, CO (US); Rebecca Amelia MITCHELL, Denver, CO (US); Guangdong ZHU, Englewood, CO (US)

(21) Appl. No.: 18/582,175

(22) Filed: Feb. 20, 2024

Related U.S. Application Data
(60) Provisional application No. 63/490,548, filed on Mar. 16, 2023.
(60) Provisional application No. 63/486,181, filed on Feb. 21, 2023.

(51) Int. Cl. G06V 10/60; G06V 10/44

(52) U.S. Cl. CPC G06V 10/60; G06V 10/44

(57) ABSTRACT

Non-invasively detecting or determining heliostat surface opto-mechanical errors (e.g., surface slope, canting, and/or tracking) is described. At least one image captured of a target reflected on a heliostat surface may be used to determine the heliostat error. This may be based on the distortion of the target reflected on the heliostat compared to the expected reflection of the target on the heliostat. Image processing and computer vision may be utilized to generate a surface slope map of the heliostat and determine the error compared to an “ideal” model of the heliostat.

### CROSS-REFERENCE TO RELATED APPLICATIONS

This application claims priority to U.S. Provisional Patent Application No. 63/486,181 filed on Feb. 21, 2023, and U.S. Provisional Patent Application No. 63/490,548 filed on Mar. 16, 2023, the contents of which are incorporated herein by reference in their entirety.

### CONTRACTUAL ORIGIN

This invention was made with United States government support under Contract No. DE-AC36-08GO28308 awarded by the U.S. Department of Energy. The United States government has certain rights in this invention.

### BACKGROUND

Accurate mirror optics are essential to achieving a well-performing concentrating solar field and ensuring that low heliostat or parabolic trough cost-per-flux is delivered to the receiver. This is a primary driver of efficiency in concentrated solar power (CSP) and concentrated solar thermal (CST) plants. However, it is difficult to determine the quality of a mirror both in the manufacturing setting and when operating in a CSP or CST plant. Thus, there remains a need for measuring heliostat surface shape at different orientations accurately.

### SUMMARY

An aspect of the present disclosure is a method including creating, using a processor, a model for a target, receiving, using the processor, an image of the target reflected on a heliostat, analyzing, using the processor, the image; and determining, using the process, an error of the heliostat. In some embodiments, the method also includes capturing, using a camera, the image; in which the capturing is performed after the creating. In some embodiments, the capturing includes moving the camera along a track, and aiming the camera at the heliostat. In some embodiments, the method also includes solving, using the processor, for a location of a camera; in which the solving is performed after the receiving, and the image is captured by the camera. In some embodiments, the solving includes identifying a nonreflected feature in the image and using the nonreflected feature to solve for a location of the camera. In some embodiments, the nonreflected feature includes at least one of a corner or an edge of the heliostat. In some embodiments, the analyzing includes identifying a reflected point, projecting the reflected point onto the model, and identifying a model target point on the model near the reflected point. In some embodiments, the reflected point includes the target. In some embodiments, the determining includes subtracting the reflected point from the model target point to get the error at the model target point. In some embodiments, the subtracting includes calculating a first surface slope for the reflected point, calculating a second surface slope for the model target point, and subtracting the first surface slope from the second surface slope. In some embodiments, the projecting includes identifying a key feature in the image that corresponds to the key feature on the target and generating a transformation matrix. In some embodiments, the transformation matrix includes a projection of the reflected point onto the model, and the identifying includes using a k-d tree. In some embodiments, the model of the target includes a plurality of model target points in a mirror reference frame. In some embodiments, the target includes a plurality of dots arranged on a surface.

An aspect of the present disclosure is a system including a processor, in which the processor is configured to create a model for a target, the processor is configured to receive an image of the target reflected on a heliostat, and the processor is configured to analyze the image to determine an error of the heliostat. In some embodiments, the system also includes a camera in which the image is captured by a camera, and the processor is configured to solve for a location of the camera. In some embodiments, the target includes a plurality of dots arranged on a surface. In some embodiments, the model of the target includes a plurality of model target points in a mirror reference frame. In some embodiments, the image includes a reflected point, and the reflected point includes the target. In some embodiments, the error includes a difference between the reflected point and one of the plurality of model target points.

### BRIEF DESCRIPTION OF THE DRAWINGS

Some embodiments of the present disclosure are illustrated in the referenced figures of the drawings. It is intended that the embodiments and figures disclosed herein are to be considered illustrative rather than limiting.

FIG. 1 illustrates a heliostat error determination method according to some aspects of the present disclosure.

FIG. 2 illustrates a heliostat error determination system according to some aspects of the present disclosure.

FIG. 3 illustrates an exemplary model for use with the heliostat error determination system and method according to some aspects of the present disclosure.

FIG. 4 illustrates an image for use with a heliostat error determination system and method according to some aspects of the present disclosure.

FIG. 5A illustrates an image of a curved trough heliostat and FIG. 5B illustrates an image of a multi-facet heliostat, both of which can be used with the heliostat error determination system and method according to some aspects of the present disclosure.

FIG. 6 illustrates a x slope error output of the heliostat error determination method for a parabolic trough heliostat, according to some aspects of the present disclosure.

FIG. 7A illustrates a x slope error output for the heliostat error determination method for two adjacent flat heliostat panels and FIG. 7B illustrates a y slope error output for the heliostat error determination method for two adjacent flat heliostat panels according to some aspects of the present disclosure.

### REFERENCE NUMERALS

100 . . . method
101 . . . system
105 . . . creating
110 . . . processor
115 . . . model
120 . . . target
125 . . . capturing
126 . . . receiving
130 . . . camera
135 . . . image
140 . . . heliostat
145 . . . solving
150 . . . processor
155 . . . location
160 . . . analyzing
165 . . . determining
170 . . . track
175 . . . reflected point
180 . . . nonreflected feature
185 . . . key feature
190 . . . model target point
195 . . . reference frame

### DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

Among other things, the present disclosure relates to methods and systems for non-invasively detecting or determining heliostat surface opto-mechanical errors (e.g., surface slope, canting, and/or tracking). The methods and systems may be done without physically contacting the heliostat surface, which means surface error may be determined without altering the heliostat while determining the error. The methods and systems may allow for error determination to be performed in factory or manufacturing settings for quality control purposes. The methods and systems may utilize at least one image captured of a target reflected on a heliostat surface to determine the heliostat error. This may be based on the distortion of the target reflected on the heliostat compared to the expected reflection of the target on the heliostat. The methods described herein may utilize image processing and computer vision to generate a surface slope map of the heliostat and determine the error compared to an “ideal” model of the heliostat.

As used herein “heliostat” may refer to an apparatus containing a moveable or driven mirror which may be used to reflect sunlight in a fixed direction. A heliostat may be substantially flat (i.e., planar) or substantially parabolic, curved, or otherwise concave. Herein, the terms “heliostat,” “mirror,” and “facet” may be used interchangeably.

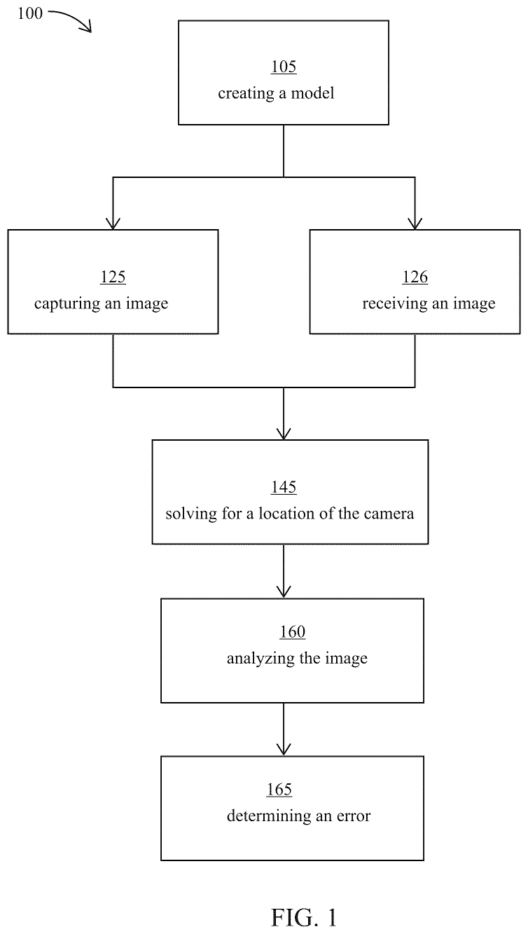

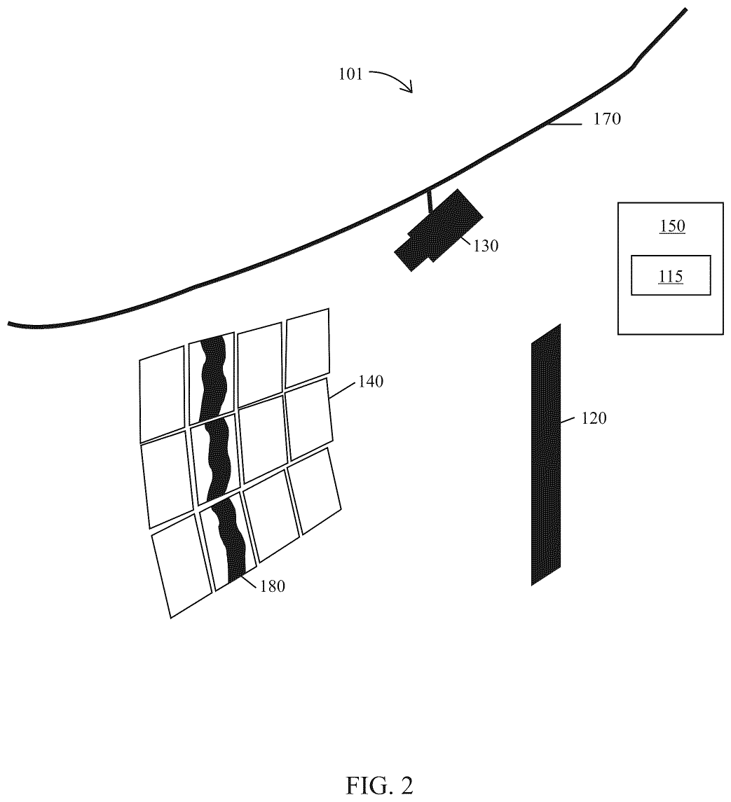

FIG. 1 illustrates a heliostat error determination method 100 and FIG. 2 illustrates a heliostat error determination system 101, according to some aspects of the present disclosure. The method 100 utilizes the components of the system 101 and the components of the system 101 may be used in the method 100.

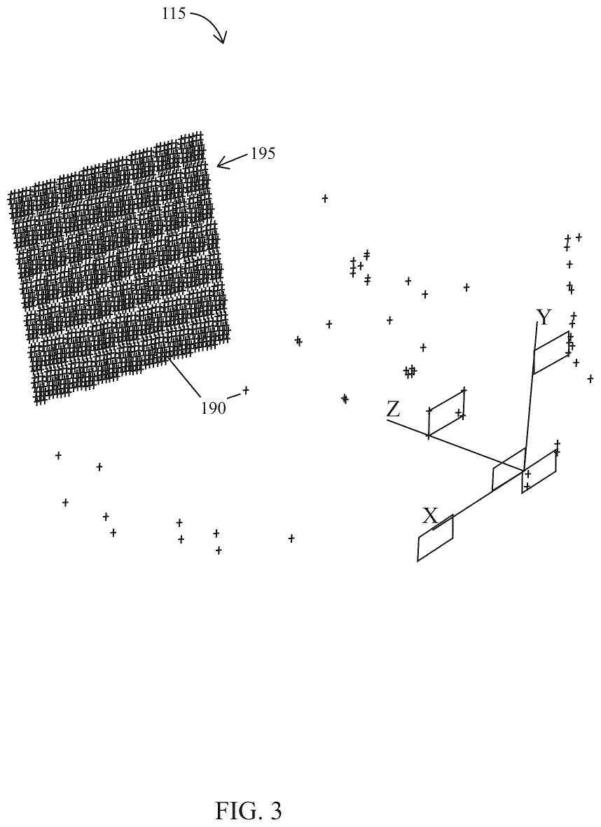

In some embodiments, the method 100 first includes creating 105 a model 115 of a target 120 using a processor 110. An exemplary model 115 is shown in FIG. 3. The model 115 of the target 120 may be a library of model target points 190 in or on a mirror (i.e., heliostat 140) reference frame 195, as shown in FIG. 3. That is, the model 115 may be an expectation of how the target 120 may appear when reflected on an ideal or correctly manufactured heliostat 140. The creating 105 may be done using photogrammetry software and/or using a mirror stand (not shown) or an assembly line (not shown) at a known location with respect to the target 120. The model target points may be used to make a slope field for a curved heliostat 140 (i.e., showing the expected different slopes at each point) or for a planar heliostat 140 (showing the reflection of the target 120 on the heliostat 140 as biased by the expected overall slope/angle of the heliostat 140.

In some embodiments, the target 120 may be a design, image, or figure on a substantially flat surface. For example, a target 120 may be a plurality of dots arranged in a shape, grid, or design on a poster board, canvas, wooden board, or other substantially flat (i.e., planar) surface. The target 120 may include a design, dots, features, or markings which are reflected as reflected points 175 on the heliostat 140 and distinctive features (i.e., distinctive from the majority of the target 120) which may be reflected as key features 185 on the heliostat 140.

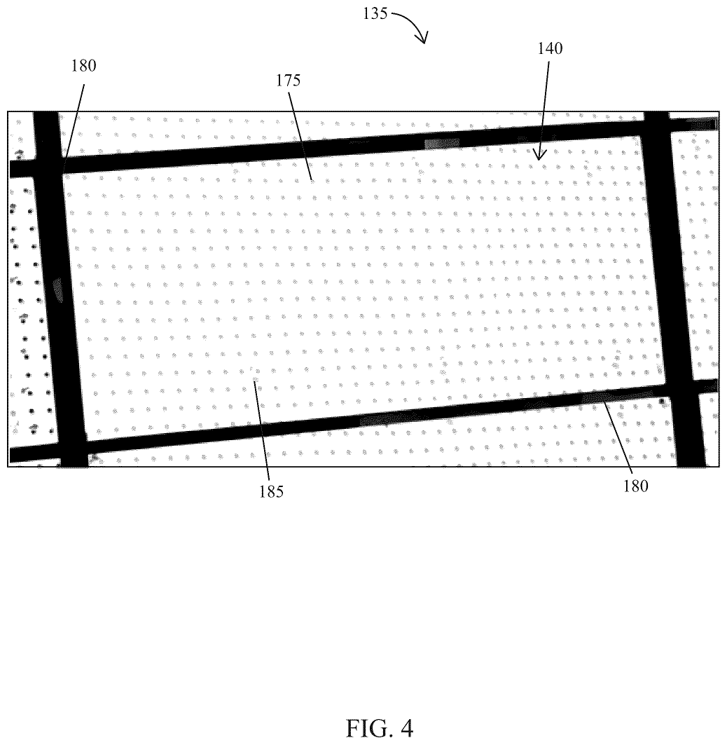

In some embodiments, the method 100 next includes capturing 125 (using a camera 130) and/or receiving 126 an image 135 (captured 125 by a camera 130) using the processor 110. The image 135 may include the target 120 as reflected in the heliostat 140. The target 120 may be positioned where it can be viewed by the camera 130 in the mirror/face of the heliostat 140. FIG. 4 illustrates an image 135. In some embodiments, multiple images 135 may be captured 125 by the camera 130. The camera 130 may be moved along a track 170 to capture 125 images 135 at different locations and/or angles (i.e., vantage points). In some embodiments, the processor 110 may combine multiple images 135 for purposes of performing the error analysis of the method 100.

The system 101 may include at least one target 120. In some embodiments, the target 120 may be a relatively stationary object. A target 120 may be made up of multiple small pieces or be a single object or design. In the exemplary image 135 shown in FIG. 4, the target 120 was a plurality of black dots arranged in a grid-like pattern on a substantially flat posterboard, but other target designs/arrangements/or features could be used. Examples of targets 120 include grids made of solid lines, grids made of dashes, grids made of a combination of dots, solid lines, and/or dashes, and/or grids made of lines of uneven thickness, on a substantially flat posterboard, cardboard, plastic, glass, fiberglass, or other. Other examples of targets 120 include vertical lines, horizontal lines, text (including letters, symbols, and/or numbers), or other designs on a substantially flat surface.

In some embodiments, the camera 130 may be moved along a track 170 or pulley system. This may allow the camera 130 to be moved while the error is determined and/or moved in between the method 100 being performed for different heliostats 140. The camera 130 may take multiple images 135, either from a single location, while moving, or from different locations, during the method 100. Using multiple images 135 in the method 100 may allow for a smaller target 120 to be used. In some embodiments, multiple cameras 130 may be used. For example, in some embodiments, rather than moving a single camera 130 along a track, two or more cameras 130 could be used, each capturing at least one image 135.

In some embodiments, the method 100 next includes solving 145 for the location of the camera 130 when it captured 125 the image 135 using the processor 150. Solving 145 may be done by identifying at least one nonreflected feature 180 in the image 135 and using the nonreflected features 180 to solve 145 for the location of the camera 130. The nonreflected features 180 may be corners and/or edges of the heliostat 140, which are known relative positions with respect to one another (i.e., based on the length and width of the heliostat 140) The nonreflected features 180 are features in the image 135 which are not reflected in the heliostat 140. The solving 145 may be done for each image 135.

In some embodiments, the camera 130 location may not be directly measured or known but may depend on various factors. The camera 130 location may be perturbed to know allowable uncertainty. The heliostat 140 corner location may be how the camera 130 location is determined. The heliostat 140 corner location may be perturbed to perturb camera 130 location. The target 120 location may be known from the system 101 set up. A ball of error phenomenon may be used to simulate uncertainty for each of these points. The image 135 may contain the reflected points 175 in the heliostat 140. This image 135 may provide pixel dimensions which may be perturbed.

The random perturbations of resolution, contouring, location (x,y,z), reflected point 175 identification, reflected point 175 known location, the number of reflected points 175, camera 130 parameters, heliostat 140 location, and/or orientation, and/or shape on the heliostat 140 as identified within distance r of the heliostat 140 can be analyzed using a processor 150 to see how this value changes with r. These perturbations may be changed in how they are perceived or analyzed/inputted into the processor 150 based on the target 120 location, camera 130 location, and/or reflected point 175 location. Based on the perturbations in the target 120 location, camera 130 location, and/or reflected point 175 location the slope measurement may be determined.

In many embodiments, an error source may be present in determining the camera 130 location. This error may be substantially reduced to measure slope within a heliostat 140 and may be unnecessary for relative canting (i.e., angle from the horizontal) of the heliostat 140 (or the substantially same error at each point). The relative heliostat 140 canting may be determined by measuring the difference in mean slope of the two heliostats 140.

In some embodiments, a maximum error of the nonreflected feature 180 may be assumed (for example, a maximum error may be assumed to be approximately +/−5 cm). Then to determine nonreflected feature 180 perturbation (and thus slope error) the processor 150 may perturb the image in increments approximately equivalent to the assumed maximum error (in this example, in increments from approximately +5 cm to approximately −5 cm). From these perturbations the slope error at each step may be calculated by the processor 150 and compared with the determined actual slope error.

In some embodiments, the maximum error of the camera 130 position perturbation may be assumed (for example, the maximum error may be assumed to be approximately 5 cm). This may be “envisioned” or “imagined” by the processor 150 in the form of a ball or sphere the size of the assumed maximum error around the camera 130 position. The initial sphere may be relatively small and be incrementally increased (in this sample, starting at approximately 5 mm in radius and in approximately 20 steps increasing to approximately 5 cm). At each radius step, approximately 100 different standard distribution points and an average value of the slope error difference.

In some embodiments, the camera 130 may be a single-lens reflex (SLR) camera, digital SLR, film camera, or other photographic device. In some embodiments, the camera 130 may have a resolution of approximately 1 point for every approximately 2.5 cm on the heliostat 140 surface in the heliostat 140.

In some embodiments, the method 100 next includes analyzing 160 the image 135 using the processor 150. The analyzing 160 may include identifying a reflected point 175 in the image 135, projecting the reflected point 175 on the model 115, and identifying a model target point 190 in the model 115 near the reflected point 175. The analyzing 160 may include using the processor 150 to identify heliostats 140 using computer vision and potentially combining photogrammetry and deflectometry, without requiring targets 120 to be attached to the heliostat 140 surface. A reflected point 175 may be a point, feature, or mark of the target 120 as reflected by the heliostat 140 and captured 125 in the image 135. The analyzing 160 may include identifying a key feature 185 in the image 135 that corresponds (i.e., is a reflection of) a key feature 185 on the target 120 and generating a transformation matrix. A key feature 120 may be a shape, design, dot, or marking which is distinctive from the majority of the target 120. The transformation matrix may be a projection of the reflected point 175 onto the model 115. That is, the analyzing 160 includes inserting a reflected point 175 from the image 135 in the model 115 and identifying a model target point 190 near the reflected point 175. The model target point 190 may be an expected reflection point from the target 120 in an ideal (or substantially error-free heliostat 140) as generated by the model 115. In some embodiments, in the method 100, a processor 150 may be used to determine surface slope error in both the x and y directions, calculated at each reflection point 175. This may be averaged over the heliostats 140 to measure relative facet canting. In some embodiments, multiple images 135 taken by the camera 130 may be merged or digitally combined so they may be analyzed 160 substantially simultaneously.

In some embodiments, the method 100 next includes determining 165 an error of the heliostat 140. The determining 165 may include subtracting the reflected point 175 from the model target point 190 to determine the error at the model target point 190. That is, the error may be the difference between the expected location of the point (i.e., the model target point 190) and the actual location of the point (i.e., the reflected point 175. The determining 165 may include calculating surface slope (i.e., the slope of the heliostat 140 surface) at the reflected point 175 and at the model target point 190, then determining the difference between these two surface slopes. The error may be determined based on the reflected point 175 as captured 125 in multiple images 135 and averaged between the multiple values to get a final error value. In some embodiments, relative canting may be determined by a processor 150 by examining images of multiple heliostat 140 simultaneously. Substantially high precision digital levels (approximately +/−0.05 or approximately 0.87 mrads) may be used to verify error determination values.

In some embodiments, the model target point 190 position perturbation may be assumed by “envisioning” or “imagining” a ball of error margin around each point. This may be done using a substantially similar error simulation technique as the camera 130 position perturbation, above. Each point may be varied within a specific radius, but a smaller error expectation.

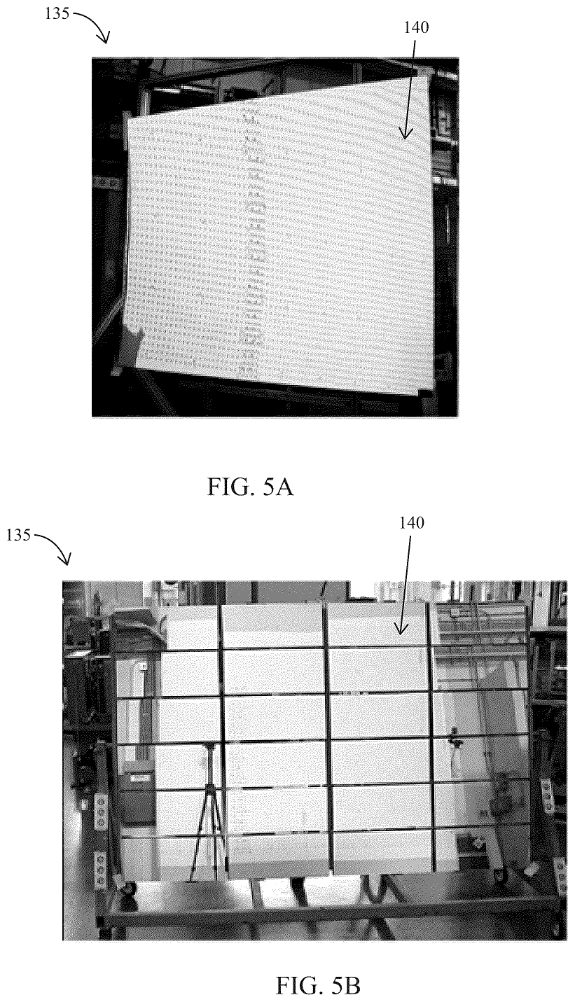

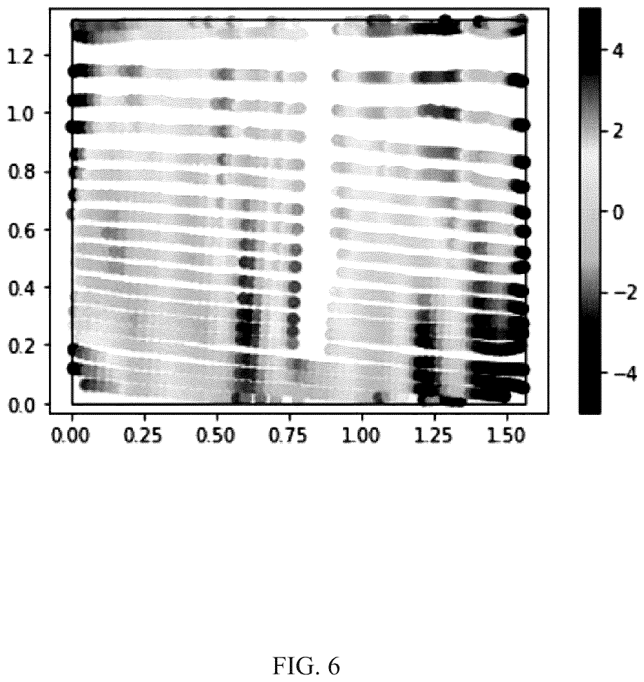

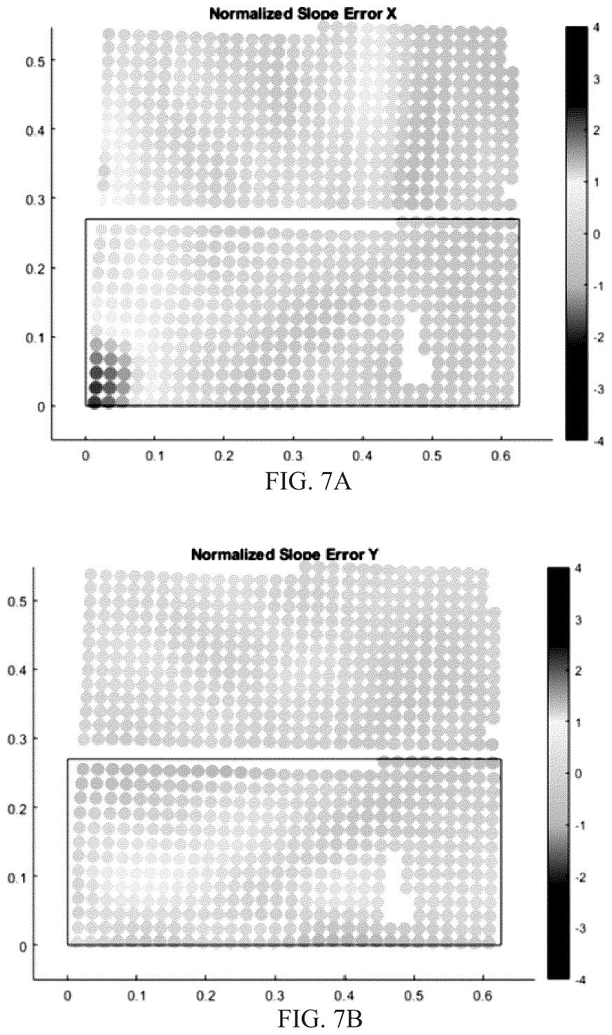

The method 100 and system 101 of the present may be used for heliostats 140 of many kinds. As way of examples, FIG. 5A illustrates an image 135 of a curved trough heliostat 140 and FIG. 5B illustrates an image 135 of a multi-facet heliostat 140, both of which can be used with the heliostat error determination system 101 and method 100. FIG. 6 illustrates a x slope error output (calculated in mrads) of the heliostat error determination method 100 for a parabolic trough heliostat 140, FIG. 7A illustrates a x slope error output (calculated in mrads) for the heliostat error determination method 100 for two adjacent flat heliostat 140 panels, and FIG. 7B illustrates a y slope error output (calculated in mrads) for the heliostat error determination method 100 for two adjacent flat heliostat 140 panels. The results shown in FIGS. 7A-B have been substantially normalized for x and y slope error.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A method comprising:
creating, using a processor, a model for a target;
receiving, using the processor, an image of the target reflected on a heliostat,
analyzing, using the processor, the image; and
determining, using the process, an error of the heliostat.

2. The method of claim 1, further comprising:
capturing, using a camera, the image; wherein:
the capturing is performed after the creating.

3. The method of claim 2, wherein:
the capturing comprises:
moving the camera along a track; and
aiming the camera at the heliostat.

4. The method of claim 1, further comprising:
solving, using the processor, for a location of a camera; wherein:
the solving is performed after the receiving, and
the image is captured by the camera.

5. The method of claim 4, wherein:
the solving comprises:
identifying a nonreflected feature in the image; and
using the nonreflected feature to solve for a location of the camera.

6. The method of claim 5, wherein:
the nonreflected feature comprises at least one of a corner or an edge of the heliostat.

7. The method of claim 1, wherein:
the analyzing comprises:
identifying a reflected point;
projecting the reflected point onto the model; and
identifying a model target point on the model near the reflected point.

8. The method of claim 7, wherein:
the reflected point comprises the target.

9. The method of claim 7, wherein:
the determining comprises:
subtracting the reflected point from the target point to get the error at the target point.

10. The method of claim 9, wherein:
the subtracting comprises:
calculating a first surface slope for the reflected point;
calculating a second surface slope for the target point; and
subtracting the first surface slope from the second surface slope.

11. The method of claim 7, wherein:
the projecting comprises:
identifying a key feature in the image that corresponds to the key feature on the target; and
generating a transformation matrix.

12. The method of claim 11, wherein:
the transformation matrix comprises a projection of the reflected point onto the model, and
the identifying comprises using a k-d tree.

13. The method of claim 1, wherein:
the model of the target comprises a plurality of model target points in a mirror reference frame.

14. The method of claim 1, wherein:
the target comprises a plurality of dots arranged on a surface.

15. A system comprising:
a processor; wherein:
the processor is configured to create a model for a target,
the processor is configured to receive an image of the target reflected on a heliostat, and
the processor is configured to analyze the image to determine an error of the heliostat.

16. The system of claim 15, further comprising:
a camera; wherein:
the image is captured by a camera, and
the processor is configured to solve for a location of the camera.

17. The system of claim 15, wherein:
the target comprises a plurality of dots arranged on a surface.

18. The system of claim 15, wherein:
the model of the target comprises a plurality of model target points in a mirror reference frame.

19. The system of claim 18, wherein:
the image comprises a reflected point, and
the reflected point comprises the target.

20. The system of claim 19, wherein:
the error comprises a difference between the reflected point and one of the plurality of model target points.
